(19) United States
(12) Patent Application Publication
(10) Pub. No.: US 2013/0264446 A1
(43) Pub. Date: Oct. 10, 2013

(54) CLAMP TYPE RETRACTOR ATTACHMENT

(71) Applicants: Erik C. Wilson, Decatur, IN (US); Aniruddha S. Deshpande, Belgaum (IN)

(72) Inventors: Erik C. Wilson, Decatur, IN (US); Aniruddha S. Deshpande, Belgaum (IN)

(21) Appl. No.: 13/805,010

(22) PCT Filed: Jun. 24, 2010
(86) PCT No.: PCT/US10/39724

§ 371 Date: Dec. 18, 2012

(51) Int. Cl. B60R 22/26

(52) U.S. Cl. CPC B60R 22/26
USPC 248/231.61; 29/525.02

(57) ABSTRACT

Provided are a retractor attachment clamp and a method for attaching a seat belt retractor to a seat frame of a bus seat includes at least one upper arm having at least one slot disposed through the at least one upper arm. At least one lower arm has a tab that is received within the at least one slot, the at least one lower arm having at least two generally parallel wing portions configured to receive a spindle of the seat belt retractor therebetween. The retractor attachment clamp includes a receiving channel that is defined by the at least one upper arm and the at least one lower arm. The receiving channel is configured to receive the seat frame. The upper arm and the lower arm are pivotable with respect to each other and are fastenable to each other.

### BACKGROUND

Embodiments described herein relate to seat belts for vehicles. More specifically, embodiments described herein relate to a seat belt retractor attachment clamp and a method for attaching a seat belt retractor to a seat frame in a vehicle.

Seats on buses typically use passive restraints, which impede the motion of the occupant within a compartment or space, instead of seat belts, which positively restrain the occupant against the seat. As such, bus seats are not typically designed to accommodate seat belts. However in some instances, seat belts are added to school bus seats. Seat belts often have retractors that retract the seat belt towards the seat.

Bus seats are formed by attaching frame members together to form one or more sub-frames, such as a seat back sub-frame and a seat cushion sub-frame. When the sub-frames are assembled to form a seat frame, the seat cushion is attached to the seat frame. The seat frame is typically fixedly attached to the floor of the bus.

Adding a seat belt retractor to the bus seat typically includes providing a non-standard seat frame so that the seat belt retractor can be attached to the seat frame. The result of providing non-standard seat frames is that the bus has two different types of seat frames, one type of seat frame for passive restraints and one type of seat frame for seat belts. Mounting plates are often welded to the seat frame to provide mounting points for the seat belt. Additionally, bracketry and drilling operations are typically conducted, adding manufacturing time, expense, and potentially weakening the seat frame at these locations.

### SUMMARY

One embodiment provides a retractor attachment clamp for attaching a seat belt retractor to a seat frame of a bus seat includes at least one upper arm having at least one slot disposed through the at least one upper arm. At least one lower arm has a tab that is received within the at least one slot, the at least one lower arm having at least two generally parallel wing portions configured to receive a spindle of the seat belt retractor therebetween. The retractor attachment clamp also includes a receiving channel that is defined by the at least one upper arm and the at least one lower arm. The receiving channel is configured to receive the seat frame. The upper arm and the lower arm are pivotable with respect to each other and are fastenable to each other.

Another embodiment provides a method of attaching a seat belt retractor to a seat frame. In one method, an upper arm of a retractor attachment clamp is provided. The upper arm has a slot disposed through a body portion of the upper arm. The upper arm has a slot disposed through a body portion of the upper arm. A lower arm of the retractor attachment clamp has a tab and at least two generally parallel wing portions. The tab of the lower arm is introduced into the slot of the upper arm. The lower arm and the upper arm pivot with respect to each other. The seat frame is introduced into a receiving channel formed by the upper arm and the lower arm. The lower arm and the upper arm are fastened together with a fastener. A spindle of the seat belt retractor is introduced generally perpendicularly between the two wing portions.

### BRIEF DESCRIPTION OF THE DRAWINGS

FIG. 1 is a perspective view of a seat frame with a plurality of retractor attachment clamps housing seat belt retractors.

FIG. 2 is a detail perspective view of the retractor attachment clamp with the seat belt retractor.

### DETAILED DESCRIPTION

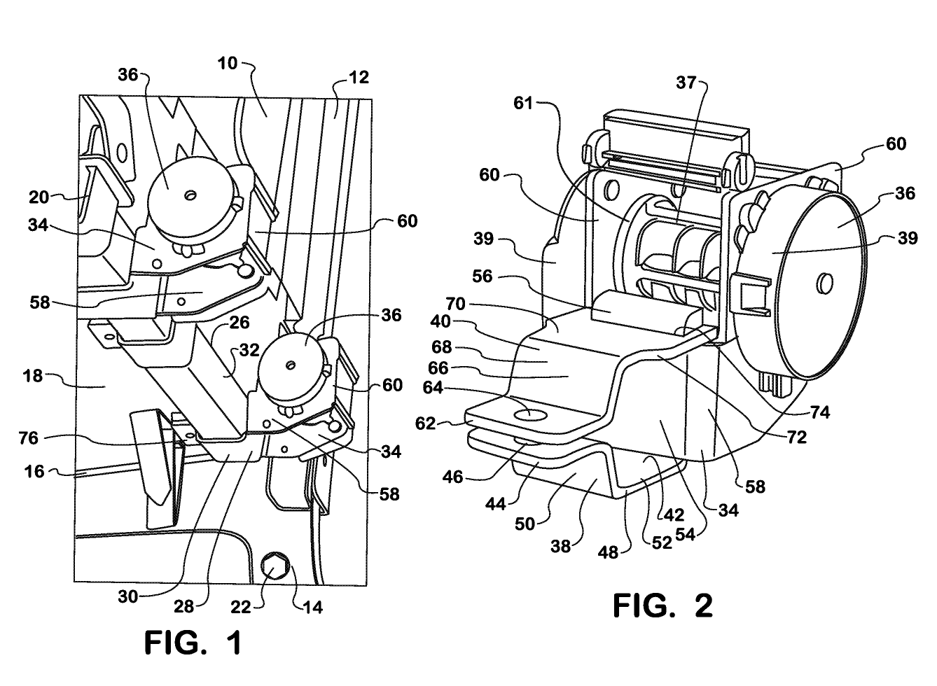

Referring now to FIGS. 1-2, a seat for use in a bus is indicated generally at 10, and is formed by attaching frame members together to form one or more sub-frames, such as a seat back sub-frame 12 and a seat sub-frame 14. When the sub-frames 12, 14 are assembled to form a seat frame 16, a seat cushion 18 is attached to the seat frame to form a bus seat 10.

The seat frame 16 may include a front cross member (not shown) and a rear cross member 20 that extend between a first seat riser 22 and a second seat riser (not shown). One or both of the seat risers 22 may be attached to a floor of the bus (not shown). The rear cross member 20 extends from at least one of the seat risers 22 generally perpendicularly from the seat riser. The rear cross member 20 may be generally elongate and generally rectangular prism-shaped, however other shapes are possible. The rear cross member 20 may have a top surface 26, a bottom surface 28 opposite the top surface, a front surface 30 and a rear surface 32 opposite the front surface.

A retractor attachment clamp 34 is used to attach a seat belt retractor 36 to the seat frame 16. The seat belt retractor 36 is a known assembly that applies tension to the seat belt to retract the seat belt towards the retractor. The seat belt retractor 36 may have a spindle 37, to which one end of the seat belt is attached, for receiving spools of the seat belt. A spring housing 39 houses a spring that applies a torque to the spindle 37.

The retractor attachment clamp 34 provides a mounting structure for the seat belt retractor 36, and is clamped to the rear cross member 20 of the seat frame 16. In this configuration, the seat frame 16 is a standard seat frame and the retractor attachment clamp 34 is attached directly to the seat frame.

The retractor attachment clamp 34 includes at least one lower arm 38 that is received within and cooperates with at least one upper arm 40 to define a receiving channel 42 configured to receive the rear cross member 20 of the seat frame 16. The receiving channel 42 is generally rectangular in cross-section, however other shapes are possible. Both the lower arm 38 and the upper arm 40 are formed of steel, however other materials are possible.

The lower arm 38 has a first flange 44 with a first attachment formation 46, such as a hole through the first flange, however other attachment formations are possible. The first flange 44 may be in a plane that is generally parallel with the bottom surface 28 of the rear cross member 20, and extends from a first clamp portion 48 of the lower arm 38. The first clamp portion 48 defines a part of the receiving channel 42, and may include a first leg 50 extending generally perpendicularly from the first flange 44, a second leg 52 extending generally perpendicularly from the first leg, and a third leg 54 extending generally perpendicularly from the second leg.

A tab 56 extends from the third leg 54 and may be generally curved, angled or hook-shaped. Two wing portions 58 extend generally perpendicularly from the third leg 54 of the first clamp portion 48. Each wing portion 58 includes a mounting portion 60 having a retractor mounting hole 61 for receiving the seat belt retractor 36. The mounting portions 60 are generally parallel and may be generally planar. The wing portion 58 and the mounting portion 60 may be generally coplanar, however other configurations are possible.

The spindle 37 is received generally perpendicularly between the two mounting portions 60 and through the retractor mounting holes 61. On exterior surfaces of each of the mounting portions 60 are the spring housings 39. The seat belt retractor 36 may be fastened to the wing portions 58, such as with bolts.

The upper arm 40 has a second flange 62 with a second attachment formation 64, such as a hole through the second flange, however other attachment formations are possible. The second flange 62 may have generally the same size and shape as the first flange 44, and may also be in a plane that is generally parallel with the top surface 26 of the rear cross member 20 and parallel with the first flange. The upper arm 40 and the lower arm 38 are fastenable to each other at the first flange 44 and the second flange 62. The second flange 62 extends from a second clamp portion 66 of the upper arm 40.

The second clamp portion 66 may include a fourth leg 68 extending generally perpendicularly from the second flange 62, and a fifth leg 70 extending generally perpendicularly from the fourth leg 68. Together with the first clamp portion 48, the second clamp portion 66 defines the receiving channel 42, which is configured to have generally the same size and shape as a standard rear cross member 20. The wing portions 58 lay in a plane that is transverse to the fifth leg 70 and transverse to the third leg 54.

A body portion 72 extends from the fifth leg 70 of the second clamp portion 66 and may have an increased width with respect to the second clamp portion 66. The body portion 72 may be coplanar with the fifth leg 70, however other orientations are possible. At least one slot 74 is disposed generally transversely through the body portion 72. To link the lower arm 38 with the upper arm 40, the tab 56 of the lower arm is introduced into the slot 74.

The slot 74 has a depth that is larger than the depth/thickness of the tab 56. In this configuration, the lower arm 38 and the upper arm 40 may hingedly pivot with respect to each other. When the attachment clamp 34 is attached to the rear cross member 20, the lower arm 38 and the upper arm 40 are pivoted with respect to each other so that the rear cross member 20 can be received between the first flange 44 and the second flange 62 and received by the receiving channel 42.

The receiving channel 42 may be configured to engage at least one surface of the seat frame 16. The receiving channel 42 of the attachment clamp 34 may be sized to engage the rear cross member 20, such that the lower arm 38 of the attachment clamp 34 engages the bottom surface 28 and the rear surface 32 of the rear cross member, and the upper arm 40 of the attachment clamp engages the top surface 26 of the rear cross member. When the rear cross member 20 is received within the receiving channel 42 of the attachment clamp 34, the first flange 44 and the second flange 62 are fastened together with a fastener 76, such as a bolt (see FIG. 1).

At least one retractor attachment clamp 34 is attached to the seat frame 16. A plurality of retractor attachment clamps 34 may be attached to the seat frame 16 at selected locations along the length of the rear cross member 20 to accommodate one or more seat belts 36 for each bus seat 10 (see FIG. 1). It is possible that a plurality of seat belt retractors 36 may be disposed on a single retractor attachment clamp 34.

What is claimed is:

1. A retractor attachment clamp for attaching a seat belt retractor to a seat frame of a bus seat, the attachment clamp comprising:
at least one upper arm having at least one slot disposed through the at least one upper arm;
at least one lower arm having a tab that is received within the at least one slot, the at least one lower arm having at least two generally parallel wing portions configured to receive a spindle of the seat belt retractor therebetween; and
a receiving channel defined by the at least one upper arm and the at least one lower arm, the receiving channel configured to receive the seat frame, wherein the upper arm and the lower arm are pivotable with respect to each other and wherein the upper arm and the lower arm are fastenable to each other.

2. The retractor attachment clamp of claim 1 wherein the at least one lower arm has a first flange and the at least one upper arm has a second flange, wherein the first flange is fastened to the second flange with a fastener.

3. The retractor attachment clamp of claim 2 wherein the at least one lower arm includes a first clamp portion defining a part of the receiving channel, and the at least one upper arm includes a second clamp portion defining a part of the receiving channel.

4. The retractor attachment clamp of claim 3 wherein the first clamp portion includes a first leg extending generally perpendicularly from the first flange, a second leg extending generally perpendicularly from the first leg, and a third leg extending generally perpendicularly from the second leg.

5. The retractor attachment clamp of claim 1 wherein the at least two wing portions each have a retractor mounting hole for receiving the spindle.

6. The retractor attachment clamp of claim 4 wherein the two wing portions lay in a plane that is transverse to the third leg.

7. The retractor attachment clamp of claim 3 wherein the second clamp portion includes a fourth leg extending generally perpendicularly from the second flange, and a fifth leg extending generally perpendicularly from the fourth leg.

8. The retractor attachment clamp of claim 7 further comprising a body portion extending from the fifth leg of the second clamp portion, wherein the at least one slot is disposed through the body portion.

9. The retractor attachment clamp of claim 7 wherein the at least two wing portions lay in a plane that is transverse to the fifth leg.

10. The retractor attachment clamp of claim 4 wherein each wing portion further comprises a mounting portion that receives a spring housing of the seat belt retractor.

11. A method of attaching a seat belt retractor to a seat frame, the method comprising the steps of:
providing an upper arm of a retractor attachment clamp, the upper arm having a slot disposed through a body portion of the upper arm;
providing a lower arm of the retractor attachment clamp, the lower arm having a tab, the lower arm having at least two generally parallel wing portions;
introducing the tab of the lower arm into the slot of the upper arm;
pivoting the lower arm and the upper arm with respect to each other;
introducing the seat frame into a receiving channel formed by the upper arm and the lower arm;
fastening the lower arm and the upper arm together with a fastener; and
introducing a spindle of the seat belt retractor generally perpendicularly between the two wing portions.

12. The method of claim 11 further comprising the step of fastening the seat belt retractor to the two wing portions.

13. The method of claim 11 further comprising the step of engaging the receiving channel with at least one surface of the seat frame.

14. The method of claim 11 further comprising the step of pivoting the lower arm and the upper arm away from each other for insertion of the seat frame into the receiving channel.

15. The method of claim 11 further comprising the step of pivoting the lower arm and the upper arm towards each other for fastening the lower arm and the upper arm together.

16. A retractor attachment clamp for attaching a seat belt retractor to a rear cross member of a seat frame of a bus seat, the attachment clamp comprising:
at least one lower arm having a first flange, a first clamp portion extending from the first flange, a generally hook-shaped tab extending from the first clamp portion, and at least two generally parallel wing portions extending from the first clamp portion, each wing portion having a retractor mounting hole for receiving a spindle of the seat belt retractor;
at least one upper arm having a second flange, a second clamp portion extending from the second flange, and a body portion extending from the second clamp portion, wherein the tab is received within the at least one slot of the at least one upper arm; and
a receiving channel defined by the at least one upper arm and the at least one lower arm, the receiving channel being configured to receive the rear cross member of the seat frame, wherein the upper arm and the lower arm are pivotable with respect to each other.

17. The retractor attachment clamp of claim 16 wherein the first flange is fastened to the second flange with a fastener.

18. The retractor attachment clamp of claim 16 wherein the receiving channel is generally rectangular in cross-section.

19. The retractor attachment clamp of claim 16 wherein the at least two wing portions each have a retractor mounting hole for receiving the spindle.

20. The attachment clamp of claim 16 wherein the first clamp portion includes a first leg extending generally perpendicularly from the first flange, a second leg extending generally perpendicularly from the first leg, and a third leg extending generally perpendicularly from the second leg, and wherein the second clamp portion has a fourth leg extending generally perpendicularly from the second flange, and a fifth leg extending generally perpendicularly from the fourth leg, and wherein the at least two wing portions lay in a plane that is transverse to the third leg and transverse to the fifth leg.
